(19) United States
(12) Patent Application Publication
(10) Pub. No.: US 2026/0188784 A1
(43) Pub. Date: Jul. 2, 2026

(54) FLUID-COOLED BATTERY MODULE CHASSIS

(71) Applicant: Wisk Aero LLC, Mountain View, CA (US)

(72) Inventors: Anthony Courville, Mountain View, CA (US); Sytse Tacoma, Christchurch (NZ); Jacob Ryser, Mesa, AZ (US)

(73) Assignee: Wisk Aero LLC, Mountain View, CA (US)

(21) Appl. No.: 19/345,378

(22) Filed: Sep. 30, 2025

Related U.S. Application Data
(60) Provisional application No. 63/739,793, filed on Dec. 30, 2024.
(60) Provisional application No. 63/766,111, filed on Mar. 3, 2025.

(51) Int. Cl. H01M 10/6568; H01M 10/613; H01M 10/625; H01M 50/204; H01M 50/224; H01M 50/242

(52) U.S. Cl. CPC H01M 10/6568; H01M 10/613; H01M 10/625; H01M 50/204; H01M 50/224; H01M 50/242; H01M 2220/20

(57) ABSTRACT

A module chassis assembly may be adapted to hold battery cells between a first end plate, a second end plate, and a plurality of panels. The first end plate may be formed to include a first plurality of channels adapted to allow fluid to pass therethrough. The second end plate may be formed to include a second plurality of channels adapted to allow fluid to pass therethrough. Each panel may be formed to include a plurality of channels adapted to allow fluid to pass therethrough. The plurality of panels may be arranged in parallel to one another. First ends of the plurality of panels may be connected to the first end plate, and second ends of the plurality of panels may be connected to the second end plate so that the plurality of channels are fluidically connected to the first plurality of channels and the second plurality of channels.

### CROSS-REFERENCES TO RELATED APPLICATIONS

This application is a non-provisional of, and claims priority to, U.S. Provisional Ser. No. 63/739,793 , filed Dec. 30, 2024, and U.S. Provisional Ser. No. 63/766,111, filed Mar. 3, 2025, each of which is incorporated herein by reference in its entirety for all purposes.

### BACKGROUND

Battery cells need to be supported in space with a structural load path. Further, most batteries need some level of operational cooling to achieve better performance, especially when discharge and charge rates are increased. Additionally, the battery cells need to be under pressure for better performance.

Conventional battery designs address the requirements separately with a structure to hold the battery cells and a separate cold plate through which fluid is pumped. However, the separate structures approach is heavy because of the amount of material needed for the separate structures. There are many examples of conventional batteries, both across electric vertical take-off and landing (eVTOL) aircraft and automotive. The cold plate is usually a stand-alone part, and the structural members are separate in conventional approaches.

Thus, there is a need for systems and methods that address the foregoing problems in order to provide more efficient and relatively lightweight solutions. This and other needs are addressed by the present disclosure.

### SUMMARY

Certain embodiments of the present disclosure relate generally to battery modules, and more particularly to a fluid-cooled battery module chassis.

In one aspect, a module chassis assembly may include a first end plate, a second end plate, and a plurality of panels. The first end plate may be formed to include a first plurality of channels adapted to allow fluid to pass through the first plurality of channels. The second end plate may be formed to include a second plurality of channels adapted to allow fluid to pass through the second plurality of channels. Each panel of the plurality of panels may be formed to include a plurality of channels adapted to allow fluid to pass through the plurality of channels. The plurality of panels may be arranged in parallel to one another. First ends of the plurality of panels may be connected to the first end plate, and second ends of the plurality of panels may be connected to the second end plate so that the plurality of channels are fluidically connected to the first plurality of channels and the second plurality of channels. The module chassis assembly may be adapted to hold a plurality of battery cells between the first end plate, the second end plate, and the plurality of panels.

In another aspect, a method of forming a module chassis assembly may include one or a combination of the following. A first end plate may be formed to include a first plurality of channels adapted to allow fluid to pass through the first plurality of channels. A second end plate may be formed to include a second plurality of channels adapted to allow fluid to pass through the second plurality of channels. A plurality of panels may be formed so that each panel of the plurality of panels includes a plurality of channels adapted to allow fluid to pass through the plurality of channels. The plurality of panels may be arranged in parallel to one another. First ends of the plurality of panels may be connected to the first end plate and second ends of the plurality of panels may be connected to the second end plate so that the plurality of channels are fluidically connected to the first plurality of channels and the second plurality of channels. The first end plate, the second end plate, and the plurality of panels may be arranged to hold a plurality of battery cells between the first end plate, the second end plate, and the plurality of panels.

In various embodiments, a floor panel may be adapted to support battery cells between the first end plate, the second end plate, and the plurality of panels. In various embodiments, the floor panel may be formed at least partially with a composite material. In various embodiments, two opposing side panels may be arranged in parallel with the plurality of panels. Each side panel of the two opposing side panels may be adapted to provide structural support to at least one panel of the plurality of panels. In various embodiments, the opposing side panels may be formed at least partially with a composite material.

In various embodiments, the module chassis assembly may be adapted to hold the plurality of battery cells in a state of compression. In various embodiments, the first end plate, the second end plate, and the plurality of panels may form a fluid path around one or more volumes for holding the plurality of battery cells. In various embodiments, the first end plate may include an inlet for a fluid and an outlet for the fluid.

In various embodiments, the fluid path may extend from the inlet and winds around an upper portion of the one or more volumes before winding around a lower portion of the one or more volumes. In various embodiments, the fluid path may extend from the inlet to guide fluid through a middle panel of the plurality of panels toward the second end plate. In various embodiments, the second end plate may be adapted to bifurcate the fluid to guide some of the fluid to a first outer panel of the plurality of panels and some of the fluid to a second outer panel of the plurality of panels. In various embodiments, the second end plate may be adapted to combine some of the fluid from a first outer panel of the plurality of panels and some of the fluid from a second outer panel of the plurality of panels and to guide the fluid to the middle panel. In various embodiments, the first end plate may be further adapted to guide some of the fluid from one or more first channels of a first outer panel of the plurality of panels to one or more second channels of the first outer panel and to guide some of the fluid from one or more first channels of a second outer panel of the plurality of panels to one or more second channels of the second outer panel.

In various embodiments, the plurality of panels may be formed at least partially with aluminum. In various embodiments, the first end plate and the second end plate may be formed at least partially with aluminum. In various embodiments, the first end plate, the second end plate, and the plurality of panels may be formed as a single-piece structure. In various embodiments, one or more legs may be coupled to the first end plate or the second end plate, the one or more legs adapted to facilitate mounting of one or more electronic components. In various embodiments, each of the first end plate and the second end plate may be further adapted to facilitate compression of the plurality of battery cells.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by either following the reference label by a dash and a second label that distinguishes among the similar components or following the reference label by parentheses enclosing a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, in accordance with embodiments according to the present disclosure.

FIG. 1B illustrates an exploded, isometric view of the battery pack, in accordance with embodiments according to the present disclosure.

FIG. 2 depicts a cross-section of at least part of an example module chassis, in accordance with embodiments according to the present disclosure.

FIG. 3 depicts a perspective view of at least part of the example module chassis, in accordance with embodiments according to the present disclosure.

FIG. 4 illustrates a diagram of at least part of the module chassis, in accordance with embodiments according to the present disclosure.

FIG. 5 illustrates another view of the module chassis illustrating a floor panel adapted to support a cumulative battery cell mass, in accordance with embodiments according to the present disclosure.

FIG. 6 illustrates a top view of an example module chassis providing battery cell compression, in accordance with embodiments according to the present disclosure.

FIG. 7 illustrates a billet plate of an end plate assembly, in accordance with embodiments according to the present disclosure.

FIG. 8 illustrates another view of the module chassis with the billet plate of the end plate assembly exposed, in accordance with embodiments according to the present disclosure.

FIG. 9 illustrates a view of the module chassis with the billet plate attached, in accordance with embodiments according to the present disclosure.

FIG. 10 illustrates fluid paths through the module chassis, in accordance with embodiments according to the present disclosure.

FIG. 11 illustrates models of the temperature contours of part of a cold plate assembly and of battery cells, in accordance with embodiments according to the present disclosure.

FIG. 12 illustrates a view of the front portion of the module chassis, in accordance with embodiments according to the present disclosure.

FIG. 13 illustrates a cross-section of a rear portion of the module chassis, in accordance with embodiments according to the present disclosure.

FIG. 14 illustrates an example method for forming a module chassis assembly, in accordance with embodiments according to the present disclosure.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

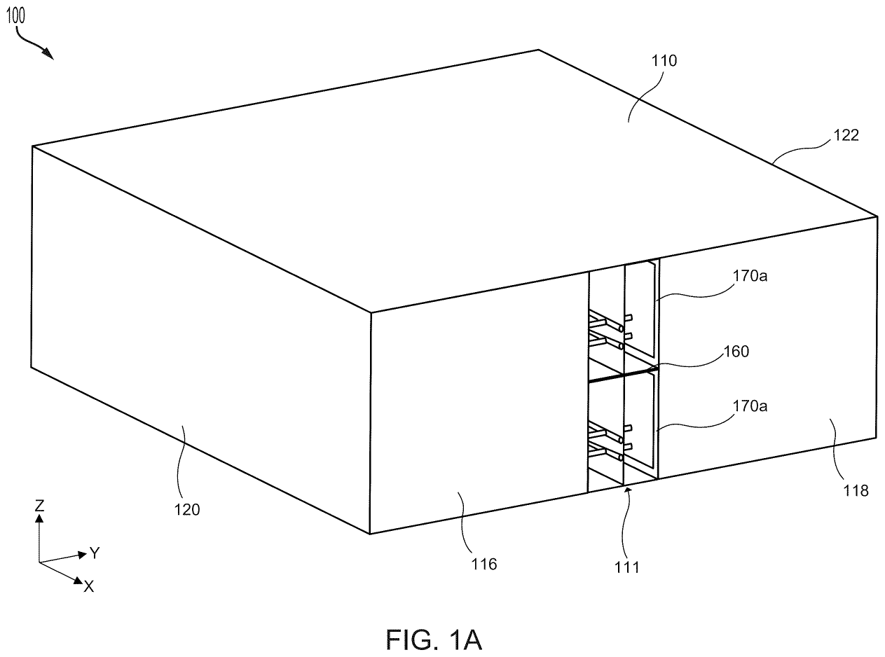

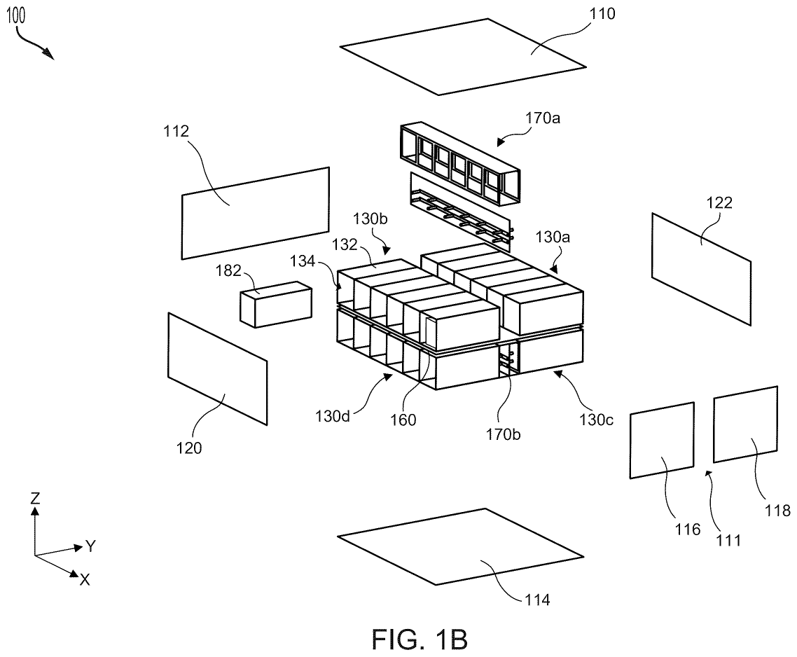

FIGS. 1A and 1B depict an example battery pack 100, in accordance with embodiments according to the present disclosure. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

The battery cells may typically be quite small, and thousands of them may be used to build a battery. For example, the majority of all Li-ion battery systems ever conceived may consist of base cells arranged into a subassembly that is welded together, commonly referred to as a module, a brick, or a sub-module. The battery cells illustrated in some of the figures may correspond to pouch cells. However, other embodiments may use other forms of battery cells, such as cylindrical cells.

The individual battery cells need to be supported in space with a structural load path. Further, most batteries need some level of operational cooling to achieve better performance, especially when discharge and charge rates are increased. Fluid cooling may be more common than air cooling. Additionally, the battery cells need to be under pressure for better performance. For example, Li-ion cells, no matter what the form factor, type, or battery architecture, may require three key cell requirements: 1) cell compression (to keep the anode, cathode, and separator from expanding and delaminating); 2) structural load path (to transfer the mass load of the cells to the wider structure); and 3) operational thermal cooling (most commonly achieved by a fluid coolant).

Embodiments of a module chassis according to the present disclosure may provide for all three key cell requirements into a single, integrated element. That is, embodiments may provide for a structural load path, as well as cooling, while providing for cell compression. Disclosed embodiments may apply to use cases any time a battery includes pouch cells and requires fluid cooling. The structural support provided by embodiments may include supporting the weight of the battery cells, mounting the modules, and supporting compression of the battery cells. Accordingly, embodiments may provide for preload on the cells.

Conventional battery designs, by contrast, address the requirements separately with a structure to hold the battery cells and a separate cold plate through which fluid is pumped. However, the separate structures approach is heavy because of the amount of material needed for the separate structures. There are many examples of conventional batteries, both across electric vertical take-off and landing (eVTOL) aircraft and automotive. However, none have an integrated solution where the coolant channels are built into the structural element as in the module chassis according to embodiments of the present disclosure. Instead, the cold plate is usually a stand-alone part, and the structural members are separate in conventional approaches.

Embodiments according to the present disclosure may provide for a module chassis that includes a structural cold plate, an element that not only cools the cells but also supports them with the same pieces that may, for example, be made of aluminum. Embodiments of the module chassis may include extruded cold plates brazed to machined end plates, which together form a hollow, sealed structure that can pass fluid through. In some embodiments, the plates may be made of aluminum. The integrated part is reinforced by bonding composite panels (e.g., strengthened with carbon fiber) to the walls and floor to handle static and dynamic loads. Without reinforcing, an aluminum-brazed cold plate may not be strong enough. The module chassis according to disclosed embodiments significantly cuts down on system mass, a key performance metric for any traction application. Minimizing weight is not only important for aircraft but also for ground-based electric vehicles. Cumulatively, in a system including 72 battery modules, for example, the savings may be multiplied by 72. Advantageously, disclosed embodiments may also allow for a reduced part count, as well as for savings on complexity and cost. Disclosed embodiments may apply to traction batteries for automotive and aviation implementations. Disclosed embodiments may apply to any implementation where battery mass is a driver.

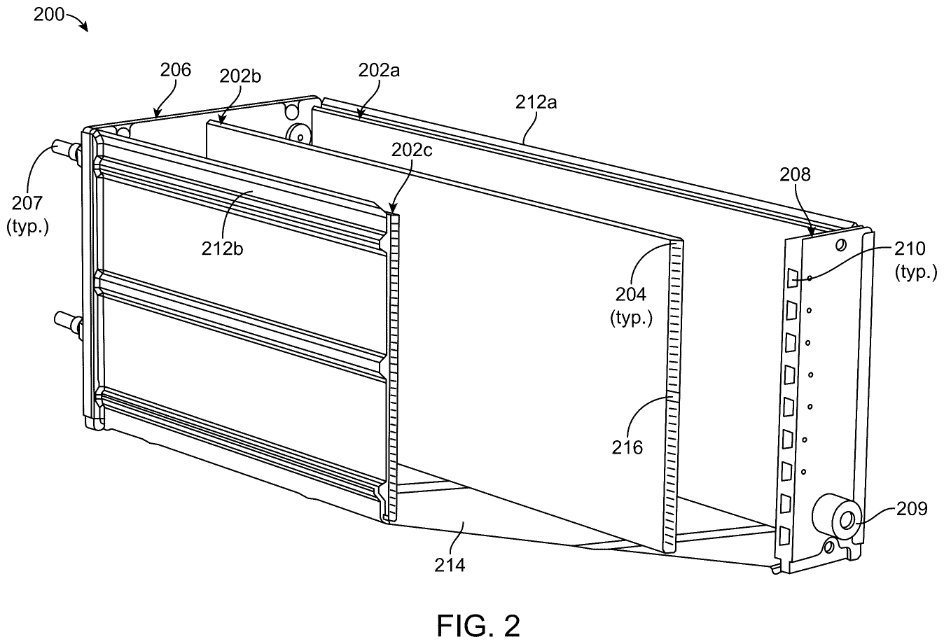

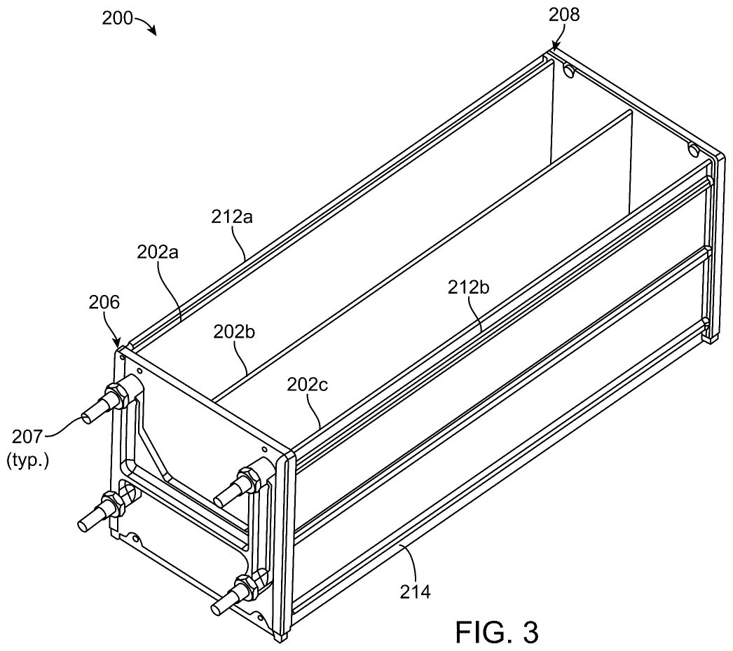

FIG. 2 depicts a cross-section of at least part of an example module chassis 200, in accordance with embodiments according to the present disclosure. FIG. 3 depicts a perspective view of at least part of the example module chassis 200, in accordance with embodiments according to the present disclosure. In some embodiments, the module chassis 200 (which may be referenced herein as a module chassis assembly) may correspond to one of the battery modules 132 of FIG. 1B. The module chassis 200 may include panels 202a, 202b, and 202c, which may correspond to a plurality of panels are arranged in parallel to one another. The panels 202a, 202b, and 202c may correspond to cold plate extrusions. In some embodiments, the panels 202a, 202b, and 202c may be formed with thin sheets of extruded aluminum. In some examples, each of the panels 202a, 202b, and 202c may be approximately a millimeter thick with a wall thickness of approximately 0.4 millimeters.

As illustrated in FIG. 2, each of the panels 202a, 202b, and 202c may be formed (e.g., by way of extrusion) to have channels 204 extending all the way through the panels 202a, 202b, and 202c. The channels 204 may correspond to longitudinal cavities adapted to allow fluid to pass through the plurality of channels from one end of a respective panel 202a, 202b, 202c to an opposite end of the respective panel 202a, 202b, 202c. In some embodiments, the module chassis 200 may be adapted to allow water (e.g., with additives) to flow through the channels 204. In some embodiments, the module chassis 200 may be adapted to allow any other suitable type of fluid to flow through the channels 204.

The module chassis 200 may include end plates 206 and 208. The end plate 206 may correspond to a module chassis front billet assembly. The end plate 208 may correspond to a module chassis rear billet assembly. The end plates 206 and 208 may be formed (e.g., machined) to have channels 210, similar to the longitudinal channels 204, to allow fluid to pass through the channels 210. The end plates 206 and 208, with channels 210, may be adapted to continue a fluid path when the end plates 206 and 208, with channels 210, are connected to the panels 202a, 202b, and 202c (e.g., by brazing) to make a fluid-tight fluid path. In some examples, the end plates 206 and 208 may be formed at least in part from aluminum.

The module chassis 200 may include side plates 212a and 212b and a floor panel 214 that are adapted to reinforce the panels 202a, 202b, and 202c and the end plates 206 and 208. The side plates 212a, 212b and the floor panel 214 may be formed from composite materials. Accordingly, the side plates 212a, 212b may correspond to composite shear panels, and the floor panel 214 may correspond to a composite floor panel. In some examples, the side plates 212a, 212b and the floor panel 214 may correspond to carbon fiber plates.

The side plates 212a, 212b and the floor panel 214 may be bonded in place to provide reinforcement necessary so the module chassis 200 can handle the load cases to which it may be subjected. Accordingly, the panels 202a, 202b, 202c; the side plates 212a, 212b; the end plates 206, 208; and the floor panel 214 may be a lightweight, single-piece structure that retains battery cells (e.g., 60 or more pouch cells) in a compressed state and that allows for fluid to run through the module chassis 200 to cool the battery cells. As such, the single-piece structure may correspond to a structural cold plate.

The module chassis 200 may include a plurality of legs 207 fixedly attached at the front of the module chassis 200. The legs 207 may facilitate structural mounting of the module chassis 200 to other components, such as a mounting plate assembly may include a DC/DC converter attached to the end plate 206 and other electronics and circuitry. Additionally, the mounting plate assembly may allow for fixing the module chassis 200 in the battery pack 100 and to other parts of an aircraft. Further, the module chassis 200 may include a plurality of legs 209 fixedly attached at the rear of the module chassis 200. The legs 209 may also facilitate the structural mounting of the module chassis 200 to other parts of the battery pack 100 and to other parts of an aircraft. The legs 207, 209 may be referenced as standoffs or studs. Together, the legs 207, 209 may support the structural load of the module chassis 200 and battery cells under high gravitational loads and impacts from hard landings experienced with aircraft.

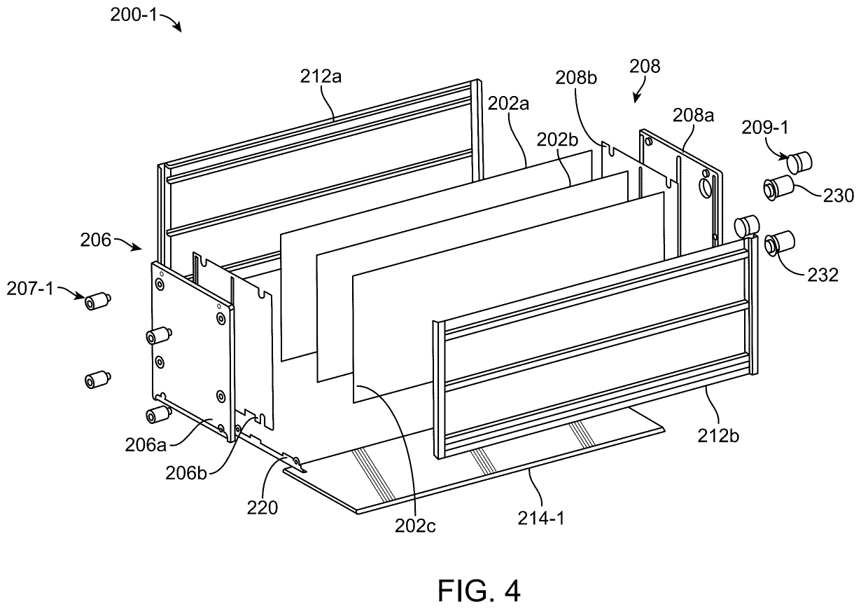

FIG. 4 illustrates a diagram of at least part of the module chassis 200-1, in accordance with embodiments according to the present disclosure. The diagram shows an exploded view of the module chassis 200-1 assembly. Illustrated are the panels 202a, 202b, 202c; the side plates 212a, 212b; the end plates 206, 208; and the floor panel 214, as well as module chassis front hard points corresponding to legs 207-1, module chassis rear hard points corresponding to legs 209-1, an inlet 230, an outlet 232 and a module chassis skid 220.

The module chassis 200 may be attached to the wider structure of the battery pack 100 via any suitable connections. In some examples, the module chassis 200 may be bolted to other components of the battery pack 100 via bolted connections at the front and the back of the module chassis 200. In some embodiments, the legs 207-1, 209-1 may be adapted to facilitate the connection.

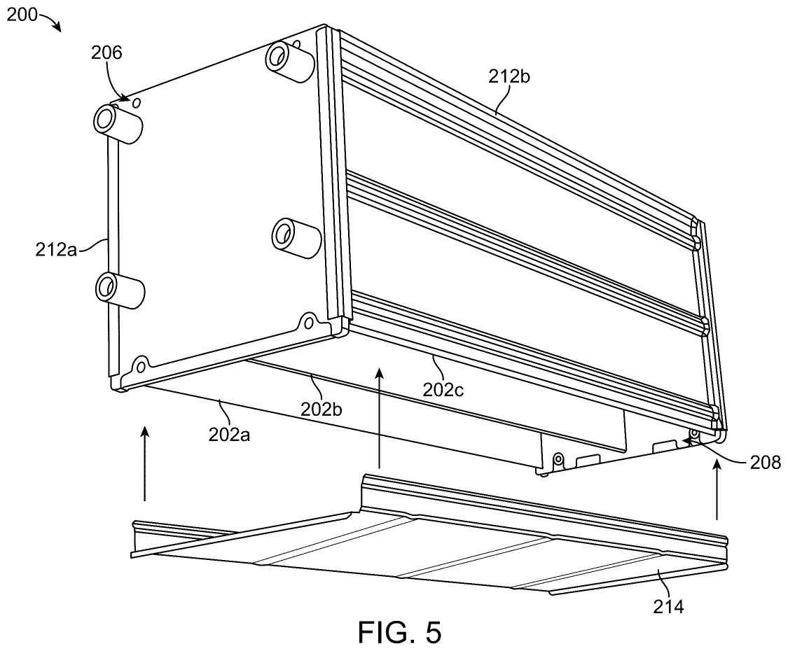

In addition to providing operational fluid cooling, the module chassis 200 may facilitate the structural load path based at least in part on supporting the cumulative battery cell mass via the floor panel 214. FIG. 5 illustrates another view of the module chassis 200 that emphasizes the floor panel 214 adapted to support the cumulative battery cell mass, in accordance with embodiments according to the present disclosure. In some embodiments, the floor panel 214 may be installed after the battery cells are populated in the module chassis 200 between the end plates 206, 208. In some embodiments, the floor panel 214 may be installed before the battery cells are populated in the module chassis 200 between the end plates 206, 208.

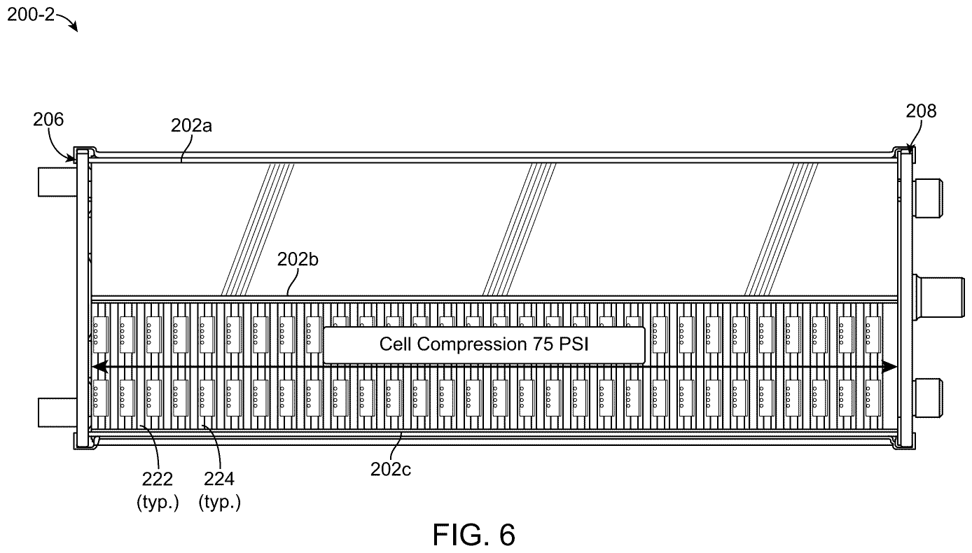

FIG. 6 illustrates a top view of an example module chassis 200-2 providing battery cell compression, in accordance with embodiments according to the present disclosure. FIG. 6 illustrates battery cells 222 in a compressed state. Pouch cells, for example, may need to be pushed on due to the cells'tendency to swell as the cells charge and discharge. Thus, the compression of the pouch cells may restrict the expansion of the pouch cells so the pouch cells do not destroy themselves.

The battery cells 222 may have foam inserts 224 in between them that are over-compressed to insert them into a fixed gap distance. Each of the foam inserts 224 may be engineered to act like a spring. The foam inserts 224 may then expand to apply cell compression. The combination of the battery cells 222 and the foam inserts 224 may be pretensioned when inserted inside the module chassis 200. In some examples, the cell compression may be in the range of 20 PSI to 75 PSI. Other compression values are possible. Accordingly, the module chassis 200 may integrate the function of resisting the pressure of the compressed battery cells 222 and foam inserts 224 with the functions of operational fluid cooling and providing structural support, all with a lightweight structure.

The end plates 206, 208 may be multipurposed. The end plates 206, 208 provide the structural support, cell structural load transfer, and cooling channels. Additionally, the end plates 206, 208 may correspond to end dams that provide cell compression. Referring again to FIG. 4, as illustrated, in some embodiments, the end plates 206, 208 may each be a combination of multiple plates. For example, the end plate 206 may be an assembly including billet plate 206a and billet plate 206b. The end plate 208 may be an assembly including billet plate 208a and billet plate 208b.

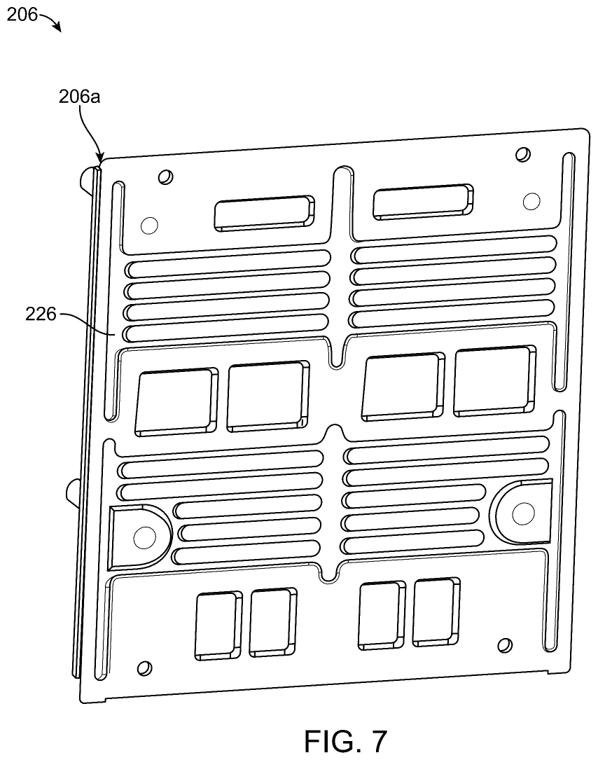

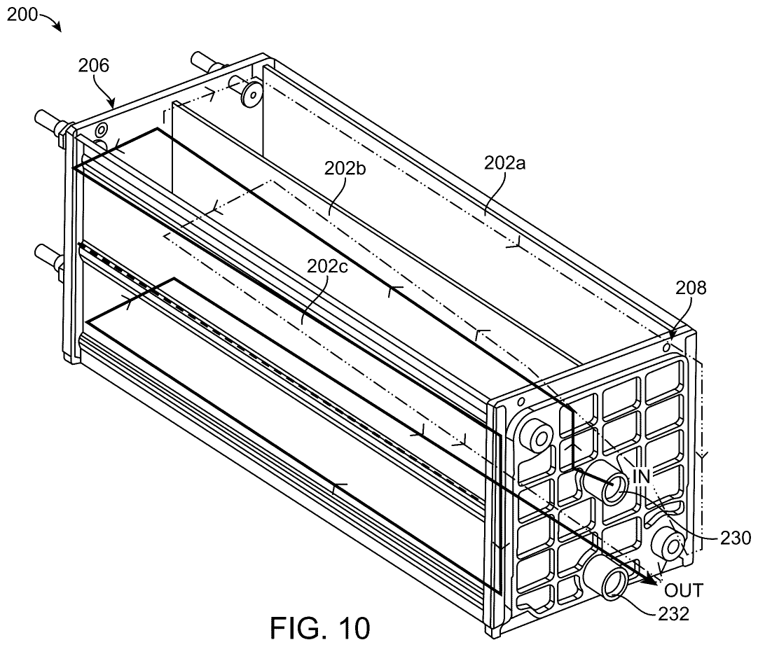

FIG. 7 illustrates the billet plate 206a of the end plate 206 assembly, in accordance with embodiments according to the present disclosure. The billet plate 206a may be formed to include channels 226 that, with the other billet plate 206b (not shown in FIG. 7, opposite from billet plate 206a), guide fluid to or from the channels 204 of the panels 202a, 202b, 202c (illustrated in FIG. 2). For example, as fluid flow through channels 204 of the center panel 202b and reaches the end plate 208 assembly, the fluid may enter one or more middle portions of the channels 226 and be guided by the channels 226 left and/or right toward the outer portions of the channels 226. From the outer portions of the channels 226, the fluid may be guided to the channels 204 of the outer panels 202a, 202c. Via the outer panels 202a, 202c, the fluid may flow toward the end plate 208. The flow of the coolant fluid is further described below in connection with FIG. 10.

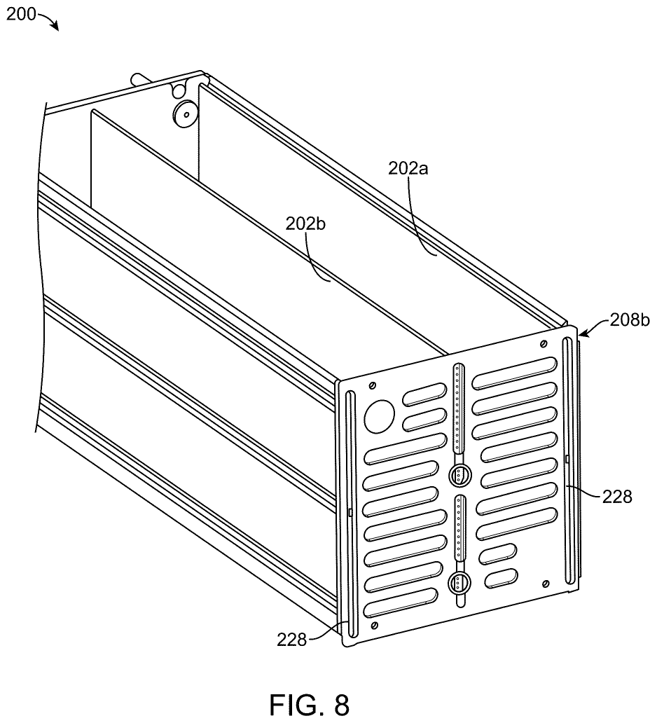

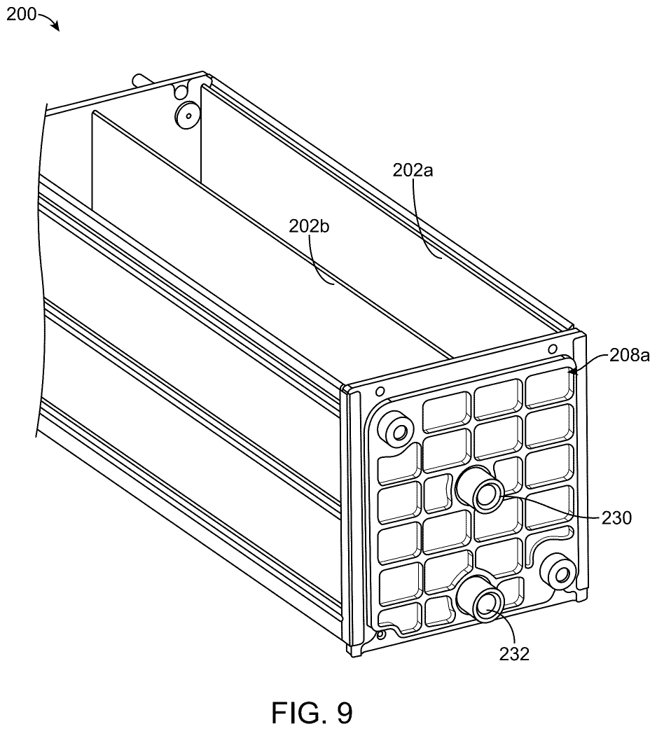

FIG. 8 illustrates another view of the module chassis 200 with the billet plate 208b of the end plate 208 assembly exposed, in accordance with embodiments according to the present disclosure. FIG. 9 illustrates a view of the module chassis 200 with the billet plate 208a attached, in accordance with embodiments according to the present disclosure. Fluid may enter the module chassis 200 via an inlet 230. Fluid may exit the module chassis 200 via an outlet 232.

When the fluid flowing via the outer panels 202a, 202c reaches the end plate 208, the fluid may enter the end plate 208 assembly via openings 228 of the billet plate 208b. Similar to the end plate 206 assembly, the billet plate 208b, together with the billet plate 208a, may form channels to guide the fluid through the end plate 208 assembly. Some of the fluid may be guided by the channels of the end plate 208 to exit the end plate 208 via the outlet 232. Some of the fluid may be guided by the channels of the end plate 208 to the panels 202a, 202b, and/or 202c.

FIG. 10 illustrates fluid paths through the module chassis 200, in accordance with embodiments according to the present disclosure. A fluid path may extend from the inlet 230 and wind around an upper portion of one of the volumes adapted to hold the battery cells 222 before winding around a lower portion of the volume. Fluid (e.g., cold water or another low-temperature coolant including a gas or gas mixture) may enter the inlet 230 and be guided by the end plate 208 to the upper subset of channels 204 of the middle panel 202b. As can be seen in the cross-section of FIG. 2, the upper channels 204 of the middle panel 202b may be separated from the lower channels 204 of the middle panel 202b by a divider 216. The channels 204 of the outer panels 202a, 202c may likewise be formed to have the upper channels 204 segregated from the lower channels 204.

Referring again to FIG. 10, the fluid may flow through the channels 204 of the middle panel 202b to the end plate 206. The fluid may be generally bifurcated at the end plate 206 to flow back toward the end plate 208 via outer panels 202a, 202c. The end plate 206, with its channels, may guide the fluid generally laterally to the upper channels 204 of the outer panels 202a, 202c. The fluid may then flow through the upper channels 204 of the outer panels 202a, 202c back to the end plate 208. The end plate 202 may then guide the fluid down to the lower channels 204 of the outer panels 202a, 202c. The fluid may proceed through the lower channels 204 of the outer panels 202a, 202c back to the end plate 206. The end plate 206 may then guide the fluid to the lower channels 204 of the middle panel 202b. The fluid may then travel through the middle panel 202b back to the end plate 208 and out the outlet 232.

Accordingly, the module chassis 200 may provide for a serpentine fluid path. In some embodiments, the serpentine fluid path may include a bifurcated portion that splits the fluid from the inlet 230 and middle panel 202b to guide portions of the fluid through the outer panels 202a, 202c before recombining and guiding the portions to the outlet 232. Advantageously, the serpentine fluid path may minimize the temperature gradient across the battery cells. The battery cells can reject so much heat that the fluid picks up heat as it goes by the cells.

Conventionally, the battery cells furthest from coolant fluid do not get cooled as well due to the temperature gradient. The battery cells, being at different temperatures, perform differently because of internal resistance being temperature dependent. Therefore, the charging of the battery cells is limited by the hottest battery cell in the pack.

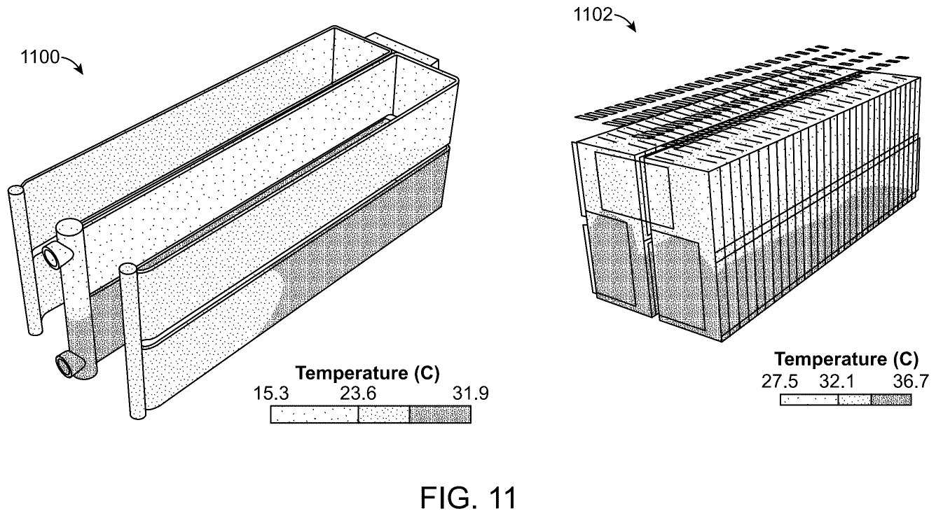

However, the module chassis 200 according to embodiments described herein may keep a very good temperature uniformity of all battery cells in the module because the serpentine flow path goes back and forth through the module in a way to ensure very low temperature gradients so that every cell from top to bottom is cooled evenly. FIG. 11 illustrates a model 1100 of the temperature contours of part of the cold plate assembly (panels 202a, 202b, 202c and end plates 206) and a model 1102 of the temperature contours of the battery cells, in accordance with embodiments according to the present disclosure. The fluid may pass by every battery cell four time, and, therefore, each battery cell may have four areas of heat-transferring contact with the cold plate assembly. For any one cell, those four areas of contact may have approximately the same average temperature. Thus, the battery cells may each have similar temperature gradients. Any element of chemistry within any cell anywhere in the battery may be within about 10° C. of every other element of chemistry in the battery.

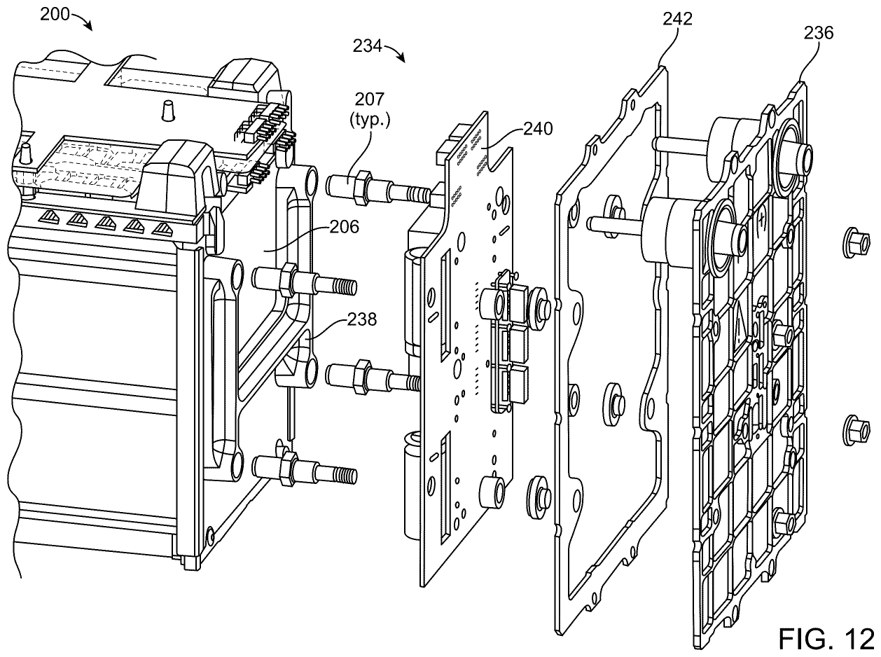

FIG. 12 illustrates a view of the front portion of the module chassis 200 with an exploded view of a front face assembly 234, in accordance with embodiments according to the present disclosure. As illustrated, the legs 207 may facilitate structural mounting of the module chassis 200 to a front face 236 of the front face assembly 234. The legs 207 may be attached to the end plate 206 via a bracket 238, each of which may be formed of titanium or another suitable material. The front face assembly 234 may include a circuit board 240 attachable to the front face 236 by way of a bracket 242 or any suitable means. The front face 236 may allow for connection to the wider battery structure. The legs 207 may correspond to load pins that allow for load to be transferred to the module casing via hard points to the front face 236 and the load pins.

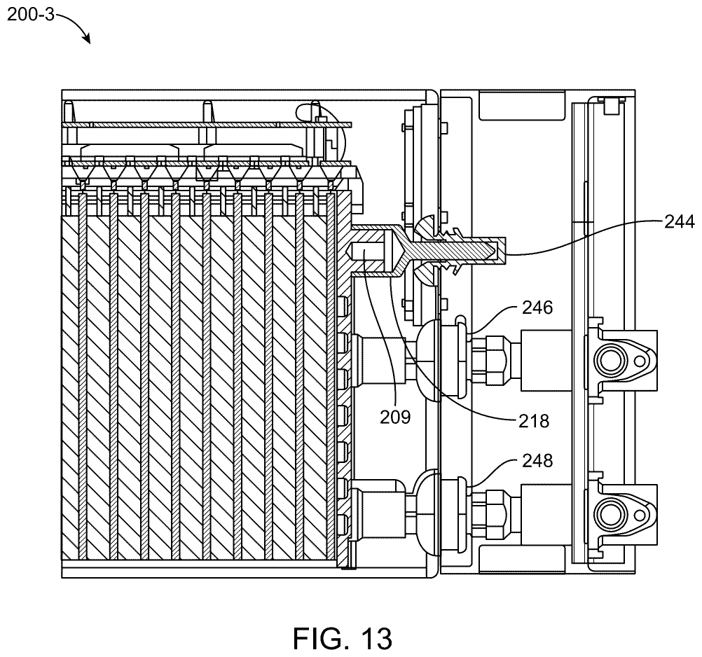

FIG. 13 illustrates a cross-section of the rear portion of the module chassis 200-3, in accordance with embodiments according to the present disclosure. A pin 218 may be attached to each leg 209 of the rear portion. Each pin 218 may slide into a bushing 244 and engage the bushing 244 with a sliding fit in order to couple the rear structure with other components. The bushing 244 may, in some embodiments, be a rubber boot. Likewise, an inlet fluid coupling 246 and an outlet fluid coupling 248 may each be adapted to engage the exterior coolant pump system with a sliding fit. The seating of the inlet fluid coupling 246 and the outlet fluid coupling 248 via the sliding fit may each open a valve so that fluid can flow into and out of the module chassis 200-3. Other embodiments, such as bolted connections, are possible.

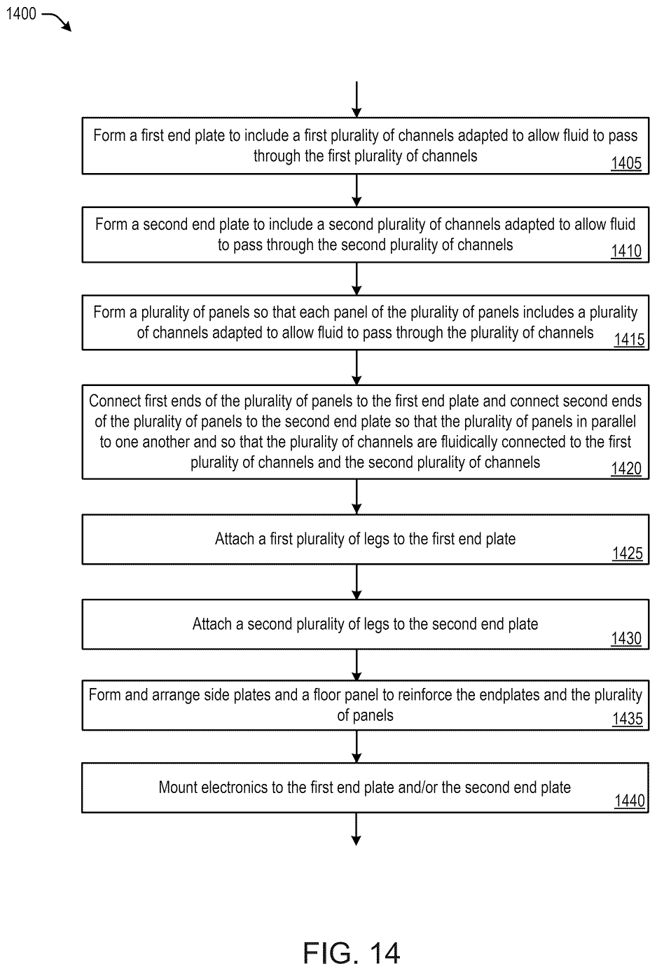

FIG. 14 illustrates one example method 1400 of forming a module chassis assembly, in accordance with embodiments according to the present disclosure. One or a combination of the aspects of the method 1400 may be performed in conjunction with one or more other aspects disclosed herein, and the method 1400 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 1405, a first end plate (e.g., end plate 208) may be formed to include a first plurality of channels (e.g., channels 210) adapted to allow fluid to pass through the first plurality of channels. As indicated by block 1410, a second end plate (e.g., end plate 206) may be formed to include a second plurality of channels (e.g., channels 226) adapted to allow fluid to pass through the second plurality of channels. As indicated by block 1415, a plurality of panels (e.g., panels 202a, 202b, 202c) may be formed so that each panel of the plurality of panels includes a plurality of channels (e.g., channels 204) adapted to allow fluid to pass through the plurality of channels. In some examples, the end plates and panels may be formed at least in part by extruding aluminum.

As indicated by block 1420, first ends of the plurality of panels may be connected to the first end plate and second ends of the plurality of panels may be connected to the second end plate so that the plurality of panels may be arranged in parallel to one another and so that the plurality of channels are fluidically connected to the first plurality of channels and the second plurality of channels. The first end plate, the second end plate, and the plurality of panels may be arranged to hold a plurality of battery cells between the first end plate, the second end plate, and the plurality of panels. In some examples, the first end plate, the second end plate, and the plurality of panels may be bonded together in the arrangement disclosed herein via welding, brazing, soldering, gluing, fastening, and/or the like.

As indicated by block 1425, a first plurality of legs (e.g., legs 207) may be fixedly attached to the first end plate. As indicated by block 1430, a second plurality of legs (e.g., legs 209) may be fixedly attached to the first end plate. In some examples, the legs may be formed from titanium or another suitable material. Again, in some examples, the legs may be bonded to the end plates by way of welding, brazing, soldering, gluing, fastening, and/or the like.

As indicated by block 1435, side plates (e.g., plates 212a, 212b) and a floor panel (e.g., 214) may be formed and arranged to reinforce the endplates and the plurality of panels. In some examples, the side plates and floor panel may be formed from a composite material or another suitable material. In some examples, the side plates and floor panel may be bonded together and to the end plates (and, in some embodiments, the panels) via welding, brazing, soldering, gluing, fastening, and/or the like. As indicated by block 1440, electronics (e.g., one or more DC/DC converters) may be mounted to the first end plate and/or the second end plate in any suitable manner. For example, electronics may be attached to the first end plate and/or the second end plate by way of one or more of the first plurality of legs and/or the second plurality of legs.

While embodiments have been described with reference to specific embodiments, those skilled in the art with access to this disclosure will appreciate that variations and modifications are possible.

It should be understood that all numerical values used herein are for purposes of illustration and may be varied. In some instances, ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure may be modified or omitted and that other elements not shown or described may be added.

The above description is illustrative and is not restrictive. Many variations will become apparent to those skilled in the art upon review of the disclosure. The scope of patent protection should, therefore, be determined not with reference to the above description, but instead should be determined with reference to the following claims along with their full scope or equivalents.

What is claimed:

1. A module chassis assembly comprising:
a first end plate formed to comprise a first plurality of channels adapted to allow fluid to pass through the first plurality of channels;
a second end plate formed to comprise a second plurality of channels adapted to allow fluid to pass through the second plurality of channels;
a plurality of panels, wherein:
each panel of the plurality of panels is formed to comprise a plurality of channels adapted to allow fluid to pass through the plurality of channels;
the plurality of panels are arranged in parallel to one another; and
first ends of the plurality of panels are connected to the first end plate, and second ends of the plurality of panels are connected to the second end plate so that the plurality of channels are fluidically connected to the first plurality of channels and the second plurality of channels; and
wherein the module chassis assembly is adapted to hold a plurality of battery cells between the first end plate, the second end plate, and the plurality of panels.

2. The module chassis assembly as recited in claim 1, further comprising:
a floor panel adapted to support battery cells between the first end plate, the second end plate, and the plurality of panels.

3. The module chassis assembly as recited in claim 2, wherein the floor panel is formed at least partially with a composite material.

4. The module chassis assembly as recited in claim 1, further comprising:
two opposing side panels arranged in parallel with the plurality of panels, wherein each side panel of the two opposing side panels is adapted to provide structural support to at least one panel of the plurality of panels.

5. The module chassis assembly as recited in claim 4, wherein the opposing side panels are formed at least partially with a composite material.

6. The module chassis assembly as recited in claim 1, wherein the module chassis assembly is adapted to hold the plurality of battery cells in a state of compression.

7. The module chassis assembly as recited in claim 1, wherein the first end plate, the second end plate, and the plurality of panels form a fluid path around one or more volumes for holding the plurality of battery cells.

8. The module chassis assembly as recited in claim 7, wherein the first end plate comprises an inlet for a fluid and an outlet for the fluid.

9. The module chassis assembly as recited in claim 8, wherein the fluid path extends from the inlet and winds around an upper portion of the one or more volumes before winding around a lower portion of the one or more volumes.

10. The module chassis assembly as recited in claim 8, wherein the fluid path extends from the inlet to guide fluid through a middle panel of the plurality of panels toward the second end plate.

11. The module chassis assembly as recited in claim 10, wherein the second end plate is adapted to bifurcate the fluid to guide some of the fluid to a first outer panel of the plurality of panels and some of the fluid to a second outer panel of the plurality of panels.

12. The module chassis assembly as recited in claim 10, wherein the second end plate is adapted to combine some of the fluid from a first outer panel of the plurality of panels and some of the fluid from a second outer panel of the plurality of panels and to guide the fluid to the middle panel.

13. The module chassis assembly as recited in claim 10, wherein the first end plate is further adapted to guide some of the fluid from one or more first channels of a first outer panel of the plurality of panels to one or more second channels of the first outer panel and to guide some of the fluid from one or more first channels of a second outer panel of the plurality of panels to one or more second channels of the second outer panel.

14. The module chassis assembly as recited in claim 1, wherein the plurality of panels are formed at least partially with aluminum.

15. The module chassis assembly as recited in claim 1, wherein the first end plate and the second end plate are formed at least partially with aluminum.

16. The module chassis assembly as recited in claim 1, wherein the first end plate, the second end plate, and the plurality of panels are formed as a single-piece structure.

17. The module chassis assembly as recited in claim 1, further comprising one or more legs coupled to the first end plate or the second end plate, the one or more legs adapted to facilitate mounting of one or more electronic components.

18. The module chassis assembly as recited in claim 1, wherein each of the first end plate and the second end plate is further adapted to facilitate compression of the plurality of battery cells.

19. A method of forming a module chassis assembly, the method comprising:
forming a first end plate to comprise a first plurality of channels adapted to allow fluid to pass through the first plurality of channels;
forming a second end plate to comprise a second plurality of channels adapted to allow fluid to pass through the second plurality of channels;
forming a plurality of panels so that each panel of the plurality of panels comprises a plurality of channels adapted to allow fluid to pass through the plurality of channels; and
connecting first ends of the plurality of panels to the first end plate and connecting second ends of the plurality of panels to the second end plate so that the plurality of panels in parallel to one another and so that the plurality of channels are fluidically connected to the first plurality of channels and the second plurality of channels;
wherein the first end plate, the second end plate, and the plurality of panels are arranged to hold a plurality of battery cells between the first end plate, the second end plate, and the plurality of panels.

20. The method of forming a module chassis assembly as recited in claim 19, the method further comprising:
arranging a floor panel to support battery cells between the first end plate, the second end plate, and the plurality of panels; and
arranging two opposing side panels in parallel with the plurality of panels, wherein each side panel of the two opposing side panels is adapted to provide structural support to at least one panel of the plurality of panels.
